(19) United States
(12) Patent Application Publication
(10) Pub. No.: US 2005/0013954 A1
(43) Pub. Date: Jan. 20, 2005

(54) Tailored tubular blanks and a method for the production thereof

(76) Inventors: Bruno W. Kaegi, Bubikon (CH); Werner Urech, Kaiserstuhl (CH)

Correspondence Address: Richard Getz;McCormick Paulding & Huber, City Place II, 185 Asylum Street, Hartford, CT, 06103-3402, US

(21) Appl. No.: 10/239,369

(22) PCT Filed: Feb. 26, 2001
(86) PCT No.: PCT/CH01/00122

(30) Foreign Application Priority Data
Mar. 23, 2000 (CH) 552/00

(51) Int. Cl. B29D 22/00

(52) U.S. Cl. 428/36.9; 428/615; 228/173.1; 228/173.6; 228/17.5

(57) ABSTRACT

To make tailored tubular blanks the circumferential weld seam and the longitudinal weld seam are so arranged that the seams do not intersect but only form an interface. In this way tailored tubular blanks that have better formability are produced.

Applicants hereby claim foreign priority benefits under 35 U.S.C. § 119 of Swiss Patent Application No. 522/00 filed 23 March 2000 and PCT Application No. PCT/CH0 1/00122, filed 26 February 2001, the disclosures of which are herein incorporated by reference.

### BACKGROUND OF THE INVENTION

1. Technical Field

The invention relates to tailored tubular blanks and methods for manufacturing them in general, and in particular to tailored tubular blanks having at least one circumferential weld seam and at least one longitudinal weld seam, and methods for manufacturing the same, in particular.

2. Background Information

Tailored tubular blanks are welded open-ended bodies either in the shape of a simple tube, or alternatively with a non-circular cross-section or a cross-section that varies along the length, which can result in a cylindrical or conical or irregular form lengthways. The shape given to them depends on their subsequent intended purpose and is designed with the latter in mind. For simplicity's sake these bodies, including those that are irregularly shaped, will be referred to as “tubes”. Tailored tubular blanks are characterised by the fact that they are made from two or more metal sheets of different thickness and/or grades of material and/or coatings. The way in which such tailored tubular blanks are constructed from metal sheets with different characteristics produces tubes the sections of which are specifically adapted to the requirements concerned. These tailored tubular blanks may be used as such or in the main example of their use further processed by shaping them, notably using hydraulic shaping (hydroforming), to make hollow bodies with complex shapes. Such hollow bodies or shaped parts are for instance employed in automotive engineering, for example as load-bearing components in the vehicle body (pillars, roof rail, sill beam sections, etc.) and in the undercarriage (running gear, chassis rails, cross-members, muffler and catalyst housings, etc.). Application fields other than automotive engineering are also possible, notably wherever spatially complex specialist parts are to be employed. The specialist term “tailored tubular blanks” is used generally in the technical terminology and therefore also in this patent application; by analogy with the conventional plane “tailored blanks” (rendered in German inter alia as “belastungsangepasste Platinen”), “tailored tubular blanks” may inter alia be rendered in German as “belastungs-angepasste Rohre”.

Tailored tubular blanks are joined using beam welding techniques (laser welding, electron beam welding or resistance arc welding), involving firstly rounding a tailored blank in the conventional way to make a tube, and then making the weld seam longitudinally along the tube. FIGS. 1a-1c and 2a - 2c show two different variants of tailored tubular blanks taken from the prior art. FIGS. 1a-1c show a first variant having parallel longitudinal seams, with FIG. 1a showing the plane tailored blank 1 from metal sheets 1 and 2 with the weld seam 3. FIG. 1b shows the welded tube (tailored tubular blank) from above with the tube's longitudinal weld seam 4, and FIG. 1c shows a cross-section taken through the tube. The present invention does not relate to such tailored tubular blanks having weld seams running exclusively lengthways, but to tailored tubular blanks as seen in FIGS. 1a- 2c with a circumferential and a longitudinal seam. FIG. 2a shows the corresponding tailored tubular blank with the metal sheets 1 and 2 and the weld seam 3, which after being formed into a tube as shown in FIG. 2b (tailored tubular blank) forms the circumferential weld seam 3 which intersects the weld seam 4 running the length of the tube. FIG. 2c shows a cross-section through such a tailored tubular blank in the region of metal sheet 2. Tailored tubular blanks with a transverse division, as shown in FIGS. 2a -2c, can exhibit drawbacks during the subsequent shaping operation (e.g. hydroforming) because the welding stresses are concentrated at the point of intersection and the heat-affected zones (the margins of the weld zone proper) of the two seams overlie one another. There is also an increased risk of welding defects at the point where the seams intersect. By controlling the welding process to maximum effect it has up till now been attempted to avoid these drawbacks as far as possible, or at least to minimise them to the extent that they make no difference in the metal forming operation. However, depending on the characteristics of the metal sheets it is difficult to select and observe suitable welding parameters.

### DISCLOSURE OF THE INVENTION

It is therefore the object underlying the invention to create tailored tubular blanks having a circumferential seam and a longitudinal seam which do not incur the stated drawbacks or at any rate only to a greatly reduced degree.

In the case of tailored tubular blanks of the type mentioned in the introduction, this object is achieved by a tailored tubular blank that has at least one circumferential weld seam and at least one longitudinal weld seam, wherein the circumferential weld seam and the longitudinal weld seam do not intersect one another when they meet at the joint.

The fact that the circumferential seam (or circumferential seams if more than one is provided) do not intersect the longitudinal seam (or longitudinal seams if more than one is provided) means that the aforementioned drawbacks are largely not applicable. Non-intersecting seams merely abut one another, with the result that they may be referred to concretely as T-joints, although as a rule the seams do not meet at a right angle. Such T-joints have a low concentration of welding stresses in the vicinity of the welded joints than is the case with intersecting seams, which results in better formability. Also the risk of welding defects when joints are being welded is smaller than when welding intersecting seams. The interfaces of the seams can also be more systematically positioned at locations that are subject to little stress in metal-forming terms.

It is a further object of the invention to create a process for producing tailored tubular blanks that do not have the stated drawbacks.

This object is achieved by a process for, or method of, making a tailored tubular blank that has at least one circumferential weld seam and at least one longitudinal weld seam, wherein the circumferential weld seam and the longitudinal weld seam are arranged in such a manner that the seams meet at a joint.

### BRIEF DESCRIPTION OF THE DRAWINGS

Exemplary embodiments of the invention will now be explained in detail with reference to the Figures, wherein:

FIGS. 1a-1c show a tailored blank, a tailored tubular blank in a plan view and a cross-section through the latter under the prior art;

FIGS. 2a -2c also show a tailored blank, a tailored tubular blank and a cross-section under the prior art;

FIGS. 3a -3c show a first exemplary embodiment of the invention, likewise with a tailored blank, a tailored tubular blank and a cross-section;

FIGS. 4a -4c show a further exemplary embodiment, in which tubular sections are joined at their ends;

FIGS. 5a and 5b show a further exemplary embodiment with a tailored blank and tailored tubular blank in a plan view;

FIGS. 6a and 6b show a further exemplary embodiment with a tailored blank and tailored tubular blank;

FIG. 7 shows an exemplary embodiment of a tailored blank; and

FIG. 8 shows another exemplary embodiment of a tailored blank.

### DETAILED DESCRIPTION OF THE INVENTION

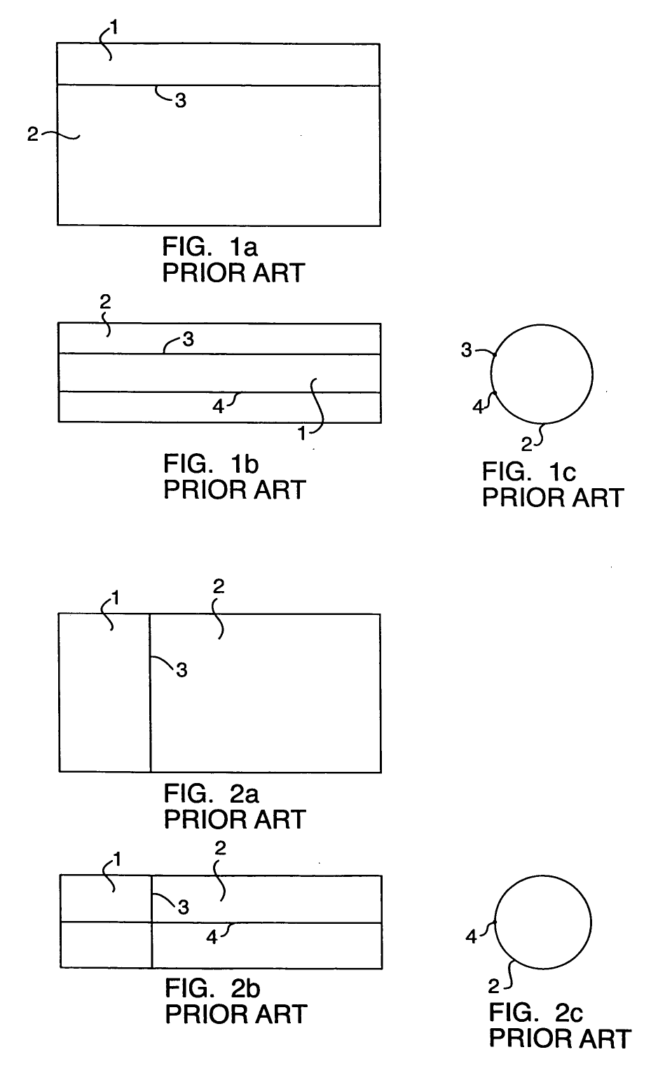

FIGS. 1a-1c show an example, already explained above, of prior art tailored tubular blanks the embodiment of which does not form a subject-matter of the present invention. FIGS. 2a -2c show an exemplary embodiment of prior art tailored tubular blanks having a longitudinal seam and a circumferential seam, the improved version of which does form a subject-matter of the present invention.

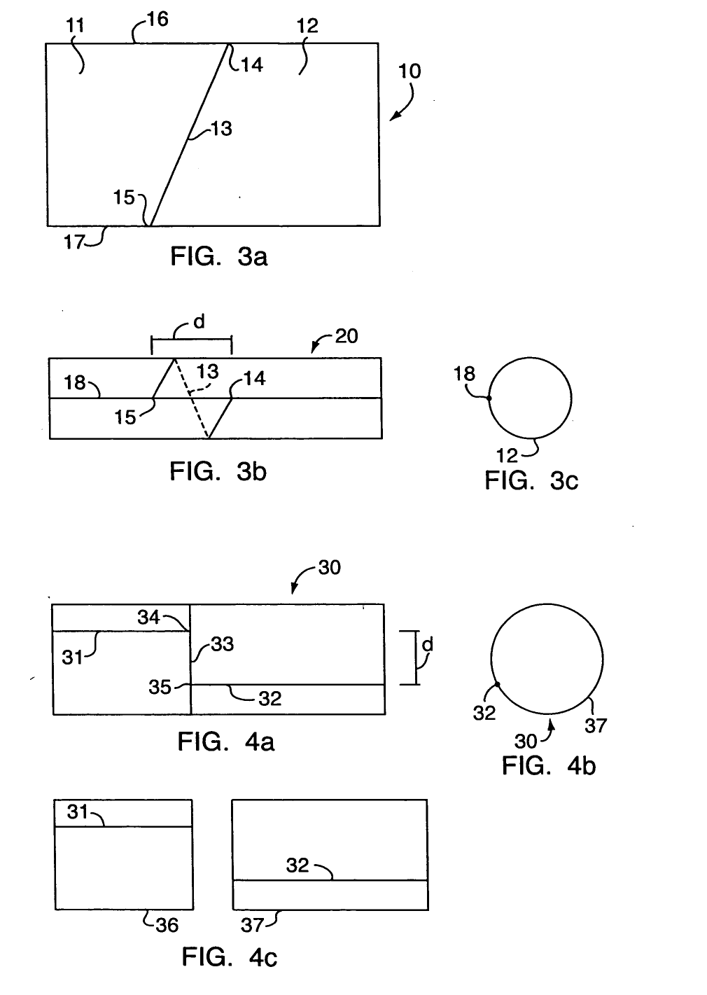

FIG. 3a shows a first exemplary embodiment of tailored tubular blanks in accordance with the invention, with FIG. 3a showing the tailored blank 10 from which the tubular can body will be shaped, using any conventional tube shaping process, and then welded to make the tube. The tailored blank 10 is formed by welding two metal sheets 11 and 12 which are joined to one another by means of a diagonal weld seam 13. The metal sheets 11 and 12 may be any desired conventional metal sheets of different thickness and/or with different sheet metal characteristics, as is fundamentally known in making tailored tubular blanks. When the tailored blank is formed into the tube by working the edges 16 and 17 of the tailored blank out of the drawing plane and away from the observer, the result is a tubular can body as in the plan view seen in FIG. 3b, in which the edges 16 and 17 have already been joined together by a weld seam 18. The weld seam 13, which runs at the end points 14 and 15 into the edges, 16 and 17 respectively, then forms with the weld seam 18 two interfaces, 14 and 15 respectively, which are spaced apart from one another by a predetermined distance. The spacing results from the oblique position of the weld seam 13 and can be selected in a correspondingly free manner and, for example, be from a few millimetres to several centimetres in size. This means that each end of weld seam 13 is only butted up to weld seam 18 and does not continuously intersect the latter, which brings about the advantages outlined above. FIG. 3c shows a cross-section through the tube 20 in the vicinity of the metal sheet 12.

FIGS. 4a -4c show another form of embodiment of tailored tubular blanks in accordance with the invention, exemplified by depicting a tube 30 which has a continuous circumferential seam 33 adjoined by two longitudinal seams 31 and 32 which do not intersect at the joint, with the interfaces being identified as 34 and 35 respectively. Here, too, the interfaces are spaced a preselected distance apart from one another. FIG. 4c shows the two tubes 36 and 37 which serve as starting parts with longitudinal weld seams 31 and 32 for tailored tubular blanks as seen in FIG. 4a. The tubes 36 and 37 are preferably in turn constituted by metal sheets of different thickness and/or having different material characteristics. The tubes 36 and 37 are then joined together contiguously with one another by welding the continuous circumferential seam 33, thereby producing the tailored tubular blanks as seen in FIG. 4a. FIG. 4b shows a cross-section taken through the tailored tubular blank 30 from FIG. 4a, in the vicinity of the tube 37. Unlike the per se known construction of tubes from tube sections, where as a rule the longitudinal seams are in alignment with one another but there may be greater or lesser or undefined deviations in the alignment of the longitudinal weld seams due to inaccuracies in the production process, in the present case relating to the construction of tailored tubular blanks the starting tubes 36 and 37 are deliberately joined together with a preselected offset “d” of the longitudinal weld seams in an industrial field and with as constant an offset “d” as possible, with the result that the manufacturing process produces a set of tailored tubular blanks with the same offset. These are also tubes 30, or rather tailored tubular blanks, which are made up of different tube parts 36 and 37.

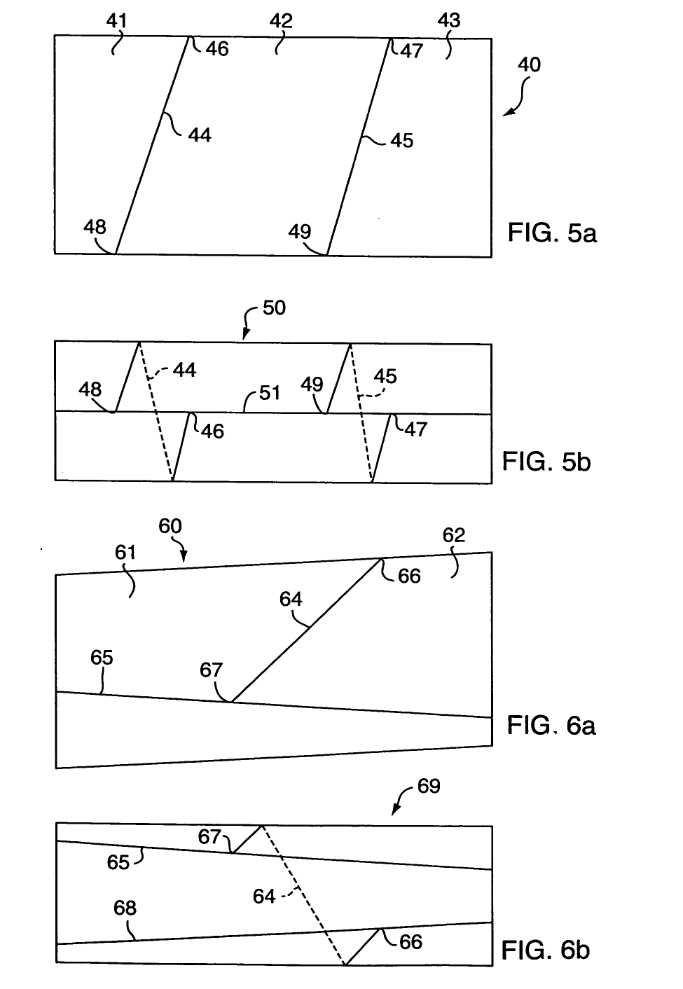

FIGS. 5a and 5b show another exemplary embodiment similar to the one in FIGS. 3a and 3b, in which, however, the tailored blank 40 is made up of three metal sheets 41, 42 and 43, to which end the weld seams 44 and 45 are provided. Corresponding interfaces 46-49 are constructed in the case of the tailored tubular blank 50 with its longitudinal weld seam 51. Here, too, all three metal sheets 41-43 may have different thicknesses and/or material characteristics or two of the metal sheets, say 41 and 43, may be identical sheets and metal sheet 42 may be a sheet with different characteristics. This can result, for instance following the reshaping of the tailored tubular blanks 50, for example by means of hydroforming, in a side rail that exhibits high strength at its centre and a lower strength, or desired upsetting behaviour, at its ends. Naturally, too, just one of the seams 44 and 45 may run diagonally and the other seam may run straight, as in the prior art, and thus intersect the longitudinal seam if that is what is wanted.

FIGS. 6a and 6b show another exemplary embodiment in which the tailored blank 60 is once again made up of three metal sheets, with one seam 65 in this case forming a longitudinal weld seam on the corresponding tailored tubular blank 69 and the obliquely situated weld seam 64 forming the circumferential seam. The metal seams 65, 62 and 63 may in turn exhibit different thicknesses and material characteristics and, as in the examples already depicted, the interfaces 66 and 67 which are created in the case of the tailored tubular blanks have the stated advantages over an intersecting path of the weld seams under the prior art.

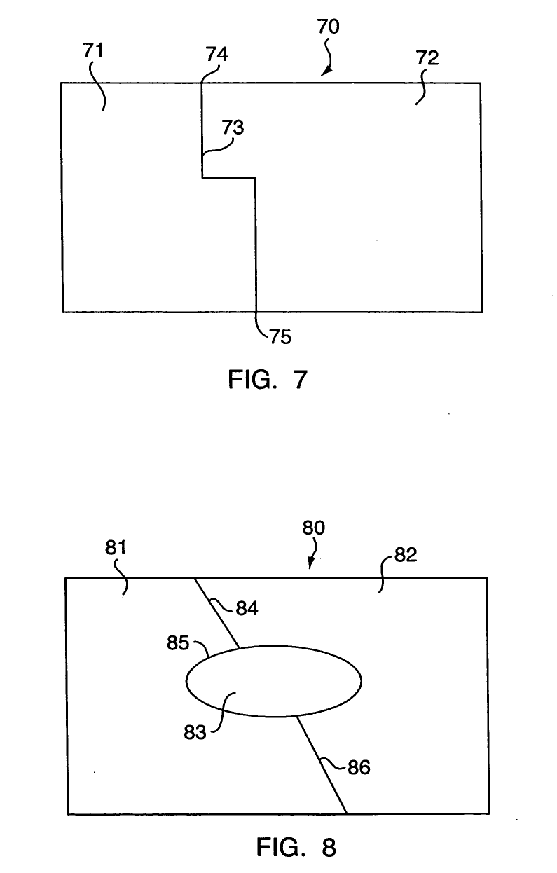

FIG. 7 shows another tailored blank in which it is readily apparent that in this instance the interfaces 74 and 75 of the weld seam 73 which connects the metal sheets 71 and 72 lie at a right angle to the longitudinal weld seam in the case of the tailored tubular blanks. This may be referred to as a T-shaped joint, although this designation may also be used for the other interfaces in accordance with the invention even if the seams do not meet exactly at right angles.

FIG. 8 shows another example of a tailored blank 80 with three welded metal sheets 81, 82 and 83, the interfaces of the weld seams 84 and 86 likewise exhibiting a predetermined offset from the longitudinal weld seam along the longitudinal weld seam of the can body constituted by this tailored blank, or by tailored tubular blanks to be welded subsequently, and forming a non-intersecting joint with the longitudinal weld seam. In place of metal sheet 83 it would also be possible to provide a recess that forms a recess on the tailored tubular blank.

Although this invention has been shown and described with respect to the detailed embodiments thereof, it will be understood by those skilled in the art that various changes in form and detail thereof may be made without departing from the spirit and the scope of the invention

1. Tailored tubular blank with at least one circumferential weld seam and at least one longitudinal weld seam, characterised in that the circumferential seam and the longitudinal seam do not intersect one another when they meet at the joint.

2. Tailored tubular blank according to claim 1, characterised in that the longitudinal seam is continuous.

3. Tailored tubular blank according to claim 1, characterised in that the circumferential seam is continuous.

4. Tailored tubular blank according to claim 1, characterised in that the interfaces of the seams are arranged a preselected distance apart from one another.

5. Tailored tubular blank according to claim 1, characterised in that it is constituted from metal sheets with different characteristics.

6. Set of a plurality of industrially fabricated tailored tubular blanks of identical construction having at least one circumferential weld seam and at least one longitudinal weld seam, characterised in that the circumferential seam and the longitudinal seam meet a joint and the interfaces are spaced a preselected distance apart from one another which is the same for all the tailored tubular blanks of the set.

7. Process for making tailored tubular blanks each of which has at least one circumferential weld seam and at least one longitudinal weld seam, characterised in that the circumferential seam and the longitudinal seam are arranged in such a manner that the seams meet at a joint.

8. Process according to claim 7, characterised in that the interfaces are a preselected distance apart from one another.

9. Process according to claim 7, characterised in that a tailored blank having at least one weld seam is made, that from the tailored blank a can body is formed, with the weld seam arranged in such a way or the tubular can body shaping done in such a way that the ends of the weld seam on the mutually opposing can body edges are spaced apart from another and that the opposing can body edges are joined by a continuous longitudinal weld seam.

10. Process according to claim 7, characterised in that at least two tubes are welded with longitudinal seams, the tubes notably being tubes having different thicknesses and/or characteristics of the metal sheets, and that the tubes with longitudinal seams offset relative to one another are joined to one another by a continuous circumferential weld seam.

11. A tailored tubular blank, comprising:
at least one circumferential weld seam, having a first end and a second end; and
at least one longitudinal weld seam;
wherein the first end of the circumferential weld seam intersects the longitudinal weld seam at a first intersection point and the second end of the circumferential weld seam intersects the longitudinal weld seam at a second intersection point, and the first intersection point is separated from the second intersection point.

12. The tailored tubular blank of claim 11, wherein the longitudinal seam is continuous.

13. The tailored tubular blank of claim 11, wherein the circumferential seam extends continuously between the first end and the second end.

14. The tailored tubular blank of claim 11, wherein the first intersection point and the second intersection point are separated by a preselected distance.

15. The tailored tubular blank of claim 11, comprising metal sheets with different characteristics joined together by the weld seams.

16. A method for making tailored tubular blanks, comprising the steps of:
providing a plurality of metal sheets;
joining the plurality of metal sheets along at least one circumferential weld seam, the circumferential weld seam having a first end and a second end;
joining the plurality of metal sheets along at least one longitudinal weld seam; and
positioning the circumferential weld seam and the longitudinal weld seam so that the first end of the circumferential weld seam intersects the longitudinal weld seam at a first intersection point and the second end of the circumferential weld seam intersects the longitudinal weld seam at a second intersection point, and the first intersection point is separated from the second intersection point.

17. The method of claim 16, wherein the circumferential weld seam and the longitudinal weld seam are positioned so that the first intersection point and the second intersection point are separated by a preselected distance.
